(19) United States
(12) Patent Application Publication
(10) Pub. No.: US 2009/0138497 A1
(43) Pub. Date: May 28, 2009

(54) Method and system for the use of probe data from multiple vehicles to detect real world changes for use in updating a map

(76) Inventors: Walter Bruno Zavoli, Palo Alto, CA (US); Hans Ulrich Otto, Hildesheim (DE)

Correspondence Address: HARNESS, DICKEY & PIERCE, P.L.C., P.O. BOX 8910, RESTON, VA, 20195, US

(21) Appl. No.: 12/289,888

(22) Filed: Nov. 6, 2008

Related U.S. Application Data
(60) Provisional application No. 60/985,879, filed on Nov. 6, 2007.

(51) Int. Cl. G06F 17/30

(52) U.S. Cl. 707/102; 707/104.1; 707/E17.018

(57) ABSTRACT

At least one embodiment of a method is described including: (1) collecting probe sensor data in an area containing roads and other drivable features; (2) processing the probe sensor data in a first manner so as to create a geospatial map database including road segments, and in a second manner to derive a subset of data related to at least one segment within the geospatial map database and being indicative of an attribute thereof, (3) statistically processing the subset data per road segment to determine one or more inferred attributes thereof, (4) comparing the created geospatial map database, in particular the road segments identified therein and said inferred attributes thereof with a pre-existing geospatial map database containing road segments and attributes thereof, and where an inconsistency in the presence or absence of a road segment, or in its geometry or topology, or in any of its attributes, is identified, (5) effecting a further action, being one of: (a) Generating a change notification, (b) Generating an alert, (c) Generating a change request, the ultimate operation of such further action being the eventual update of the pre-existing geospatial map database such that the former attribute is replaced with the inferred attribute, and/or the insertion, deletion or correction, as far as geometry and topology is concerned, of the road segment. Alternative methods are also described.

### PRIORITY STATEMENT

The present application hereby claims priority under 35 U.S.C. §119 on U.S. provisional Patent Application No. 60/985,879 filed Nov. 6, 2007 the entire contents of which is hereby incorporated herein by reference.

### BACKGROUND

More and more use is being made of electronic maps, such as for routing, navigation, finding addresses, and points of interest, and generally answering all manner of queries involving spatial information. New uses are continually appearing and some of them relate to safety applications. As a consequence of all these uses of maps, it is becoming more and more necessary to identify change in the real world and reflect that change in the electronic map in a timely fashion.

In the past this has been a very difficult, time consuming, expensive task, with some items failing to be promptly entered and other items being entered erroneously. For example, road map databases for a country the size of the US are enormous. They represent hundreds of millions of individual facts. Man and nature are continuously changing or adding to those facts. Mapping companies are continuously looking for new methods to find changes, or even an indication of change, so they may more effectively research the issue and update the electronic map.

In the recent years, new technologies have come on line including, aerial and satellite photography, terrestrial based imagery from Mobile Mapping Vehicles, GPS and other position determination equipment and their enhancements, GIS platforms and spatial database engines to facilitate making and housing the changes, Lidar, Laser Scanners, radars and, of course, the Internet. These technologies have helped create map updates faster, cheaper, and more accurate, and have also enabled maps to carry new forms of information such as 3D buildings and the like. Still, there is a need for faster, cheaper updates. It is an object of the present invention to overcome this problem.

### SUMMARY

Accordingly, at least one embodiment of the invention provides methods for creating and/or updating map databases so as to result in an improved map database as proposed in the appended claims.

### DESCRIPTION OF DRAWINGS

FIG. 1 shows a block diagram detailing various component parts of a map database update system,

FIG. 2 shows a flow diagram of the processing involved in the system according to one embodiment of the invention,

FIG. 3 shows a flow diagram of the processing involved in the system according to a further embodiment of the invention, and

FIG. 4 shows a flow diagram of the processing involved in the system according to a yet further embodiment of the invention.

### DETAILED DESCRIPTION

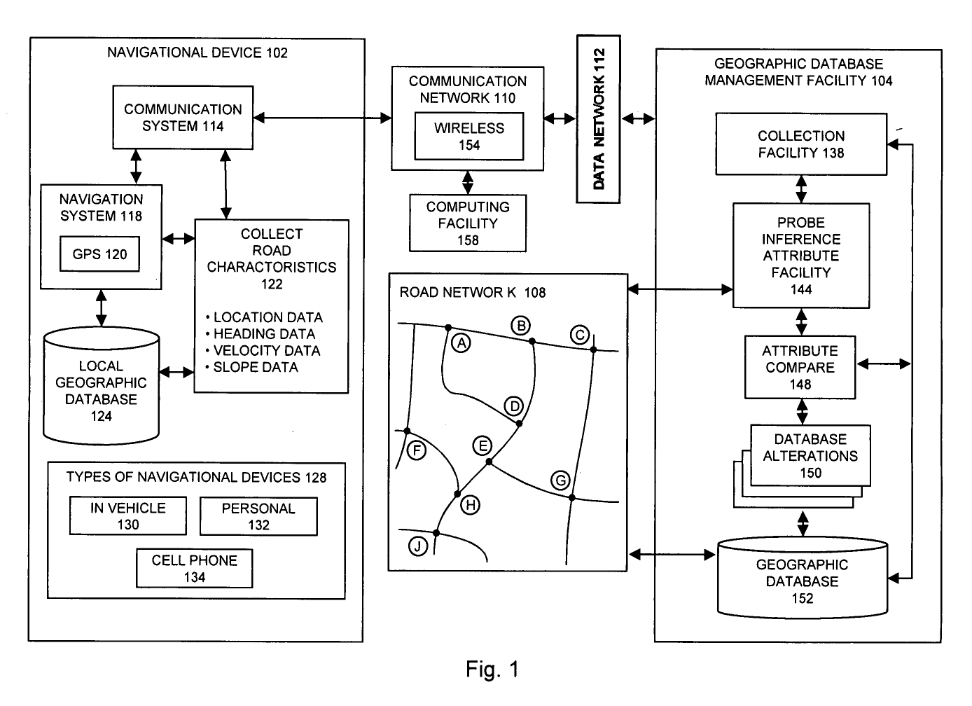

The present invention makes use of vehicles as probes, where the vehicles are equipped with sensors 204 that collect information such as position, speed, heading, slope, time, and the like, that may be used to infer the changing conditions of a road network 108 over time. In embodiments, a system according to the principles of the present invention may collect data from a plurality of vehicles that are traversing a road network 108 over a first period of time, and then compare this data to a plurality of vehicles traversing the same road network 108 over a second period of time. By comparing these two sets of data, changes in travel patterns may be used to infer a change in road conditions. For example, if in the first time period drivers travel both North and South over the same or a closely similar locus of points (likely a road), and in the second period of time travel only North for the same locus of points, it may be inferred that a significant change has been made to the direction of travel allowed on the road that represents this collection of data, and that the road has been made a one-way road. Similarly, if most vehicles merely slow before proceeding through a specific intersection in a first period of time, but in a second period of time all come to a full stop, it may be inferred that a new stop sign has been placed at the intersection. By tracking the behavior of vehicles over time, a geographic database provider may be provided a timelier indicator of changes in the road network 108, which may lead to more timely changes in the geographic database 152. These changes may then lead to user updates that better reflect the current state of a road network 108. Referring to FIG. 1, a navigational device 102 may include a navigation system 118 that includes GPS, differential GPS, inertial navigation system (INS), or the like; a local geographic database 124; a communication system 112 for connection to a geographical database management facility 104; a facility for the collection of road characteristics 122; and the like. In embodiments, the navigational device 102 may be permanently installed in a vehicle 130, such as in the dash of a vehicle; temporarily installed in a vehicle 130, such as mounted on the dash of a vehicle; located in the vehicle but not mounted to any feature of the vehicle, such as a personal 132 handheld device; located in the vehicle as a part of a cellular phone 134; and the like. In embodiments, the navigational device 102 may also be used to track the travel patterns of nonvehicle motion, such as for a biker, a pedestrian, or the like. In embodiments, the navigation system 118 may use its embedded GPS 120 facility to determine its position, speed, heading, slope, and the like, in combination with the local geographic database 124, to provide a user of the navigational device 102 with information associated with their current travel conditions, such as location in relation to a stored map in the local geographic database 124, estimated time of arrival given a destination, location of proximate points of interest and information thereof, and the like. The facility for collecting road characteristics 122 may collect said information from the navigation system 118 and local geographic database 124 over a period of time, and either store the information for later transmission, or transmit the information real-time through the navigation device's 102 communication system 114.

The navigational device 102 may be provided communication facilities through a communication network 110 and data network 112 to the geographic database management facility 104. The communication network 110 may be a wireless 154 communications network 110 through a service provider, such as provided through a cellular network; a wireless 154 communications network 110 through an area network, such as provided through a Wi-Fi hot spot or WiMAX; a wired connection to a computing facility 158, such as provided to a home personal computer; and the like. In embodiments, the data network 112 connected between the communications network 110 and the geographic database management facility 104 may be a local area network (LAN), personal area network (PAN), campus area network (CAN), Metropolitan area network (MAN), wide area network (WAN), global area network (GAN), internetwork, intranet, extranet, the internet, and the like.

The geographic database management facility 104 may include a collection facility 138 that may collect road characteristic 122 data from a plurality of navigation devices 102, or other non-navigation probe devices such as a truck monitoring systems, and the like. This data may then be provided to a probe inference attribute facility 144 where road segment attributes may be inferred from the collected probe data. Probe inference attributes may then be compared 148 with the attributes stored in the geographic database 152, where differences may be detected and interpreted, and where notifications 220 may be generated for possible generation of geographic database alterations 150. Ultimately, database alterations 150 may be provided to the geographic database 152 and on to users as a part of an update facility to the local geographic database 124.

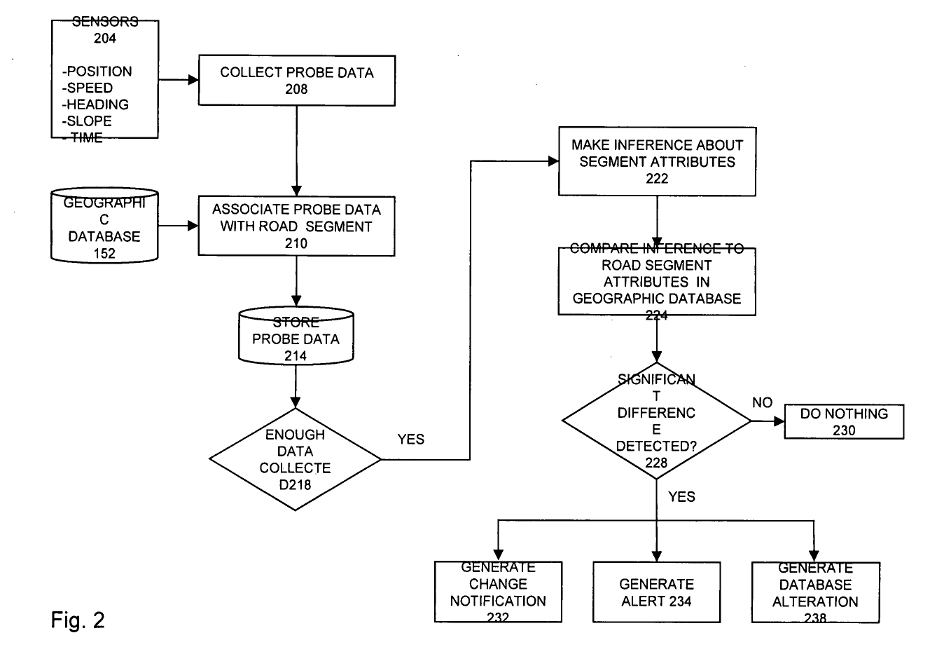

Referring to FIG. 2, in embodiments a plurality of vehicles may collect probe data 208 from on-board sensors 204 (e.g. GPS based system), such as for position, speed, heading, slope, time, and the like. The collected probe data 208 may be associated 210 with a road segment, where the road segment may be retrieved from the geographic database 152. Collected data from the plurality of vehicles 212 may be stored 214, where data may be collected until enough data is collected 218 for subsequent analysis. In embodiments, the association 210 may be provided in the vehicle 202, in the navigation device 102, in the geographic management facility 104, in an intermediate location, in a later process step, and the like. When enough data is collected 218, the probe data may be analyzed to make inferences about segment attributes, such as the likely presence of a stop sign, a yield sign, a traffic light, a no U-turn, a no left turn, a no right turn, a blinking warning light, a blinking stop light, a speed limit sign, a one-way sign, a detour, a closed road, a merge, the number of lanes, a new POI and the like. In addition, inferences may be made about road segments, such as the existence of a new road or the like. Once these probe attribute inferences are made 222, the probe inference attributes may then be compared 224 to road segment attribute data stored in the geographic database 152. Segments may also be analyzed and compared to determine the existence, geometry, and attributes associated with a new road or the like, which in embodiments, may also be performed manually A comparison 224 between the likely value of a road segment attribute as characterized by inference, and the road attributes as stored in the geographic database 152 may be performed to determine whether there are any significant differences detected 228. In embodiments, the results of the comparison 224 may determine that there are no significant differences such that the action is to do nothing 230. In embodiments, if significant differences are detected 228, a plurality of actions may follow, such as to generate a change notification 232, to generate an alert 234, to generate a database alteration 238, or the like.

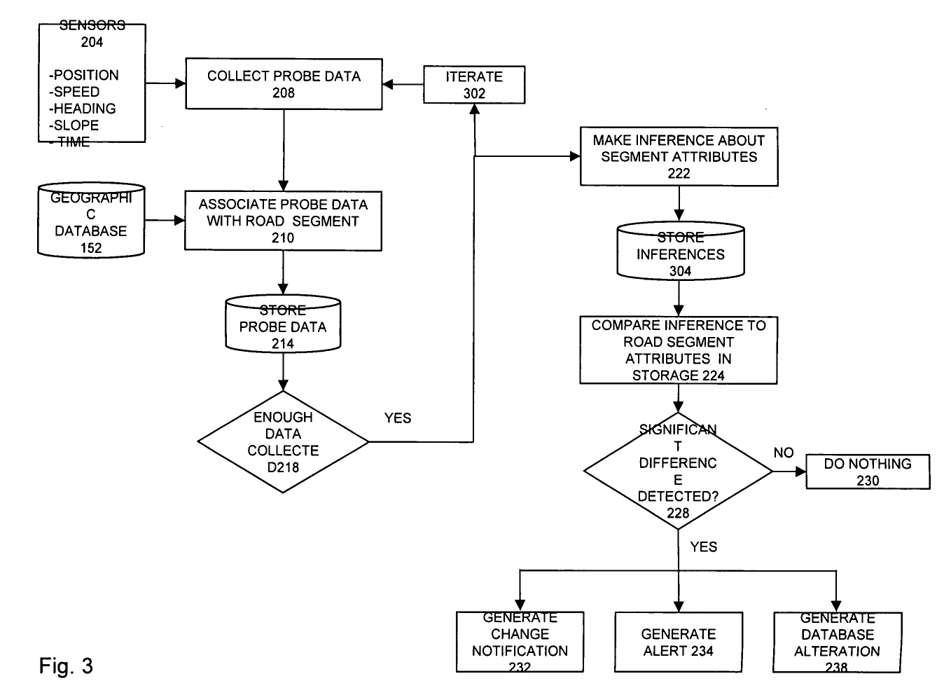

In embodiments, the process of collecting 208 and storing probe data 214 associated with road segment data from the geographic database 152 may be continuously performed. FIG. 3 shows an alternate of the process flow described in association with FIG. 2, where the process of collecting probe data 208 may be iterated 302. Iteration 302 may be performed a plurality of times, or continuously, as an on-going process to collect and make inferences about segment attributes 222. Iteration 302 may be a function of the entire probe data set or a function of probe data along specific segments. Further, FIG. 3 illustrates that probe inference attributes may be stored 304 for subsequent comparison to previously collected probe inference attributes, such as comparing a first probe inference attribute made for a given road segment to a second probe inference attribute made for the same road segment at a subsequent time. In embodiments, this process may be continuous, and represent an ongoing comparison 224 of inferred attributes for the purpose of detecting significant differences 228 over time.

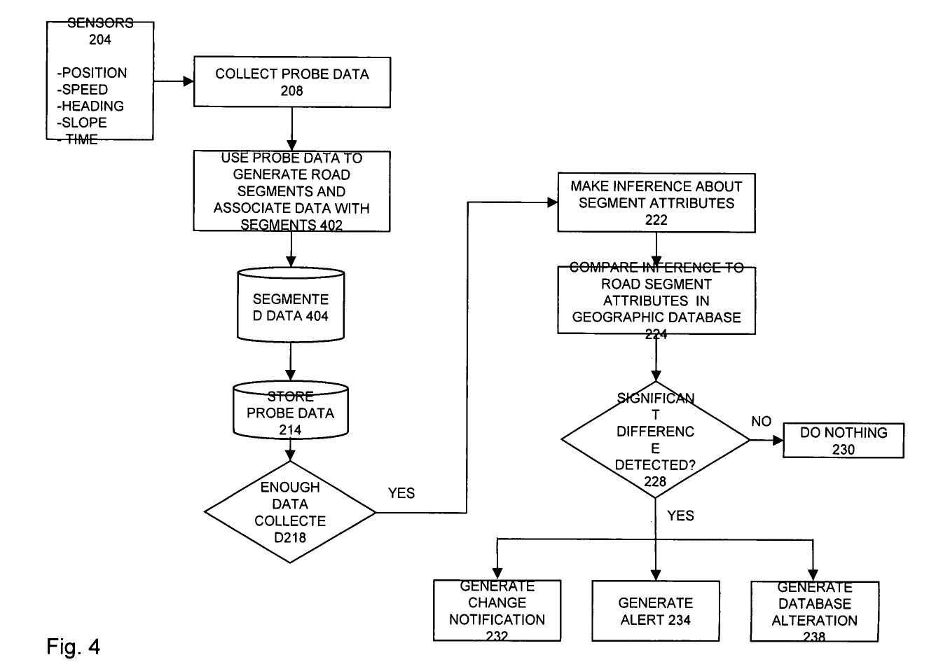

In embodiments, the process of collecting probe data 208 may be used to generate road segments and associate the data with those road segments 402. FIG. 4 shows an alternate of the process flow described in association with FIG. 2, where the collected probe data 208 may be used to create road segments with the probe data, rather than initially comparing against the geographic database 124. In this case, the probe data may still be stored 214 and forwarded for making inferences about segment attributes 222 when enough data is collected, but no geographic database 152 may be required for initial association of probe data to road segments.

In embodiments, vehicle probe sensor data may be collected and associated with a road segment stored in a geographical database 152, where the collection may be made while the vehicle 202 drives on a roadway, or off a roadway, such as at parking lots and points of interest. The road segment associated with probe sensor data may be communicated to a collection facility where a plurality of road segment associated probe sensor data may be collected, where the probe sensor data may be from a plurality of vehicles traversing an area. In embodiments, the probe data may be communicated to the collection facility after a minimum number of road segments are collected in association with the probe data, and further, may represent an on-going process that continuously generates probe data sets for analysis and storage. The plurality of data may then be analyzed for patterns of probe performance, where a probe inference attribute may be made from the probe performance, and further, a comparison of the probe inference attribute may then be associated with an attribute of the road segment from the geographic database 152. If the comparison results in a significant difference 228 being detected between the probe inference attribute and the geographic database 152 attribute, then a segment attribute alteration may be requested, such as an alert for a database attribute change, a database attribute change, a database attribute change comprising an attribute change consistent with the probe inference attribute, and the like. In embodiments, the association of the probe sensor data with the road segment data may be accomplished within an in-vehicle navigation system, after the probe sensor data has been communicated from an in-vehicle navigation system, and the like. In embodiments, communication to the collection facility may include sending the probe sensor data over the Internet, such as through wireless communication system from the vehicle, through a wired communication from the navigation device, facilitated by removing the navigation system from the vehicle and communicating the associated sensor probe data from the navigation system through the Internet to the collection facility, and the like. The probe data may be stored on removable media that can be uploaded to the Internet using various techniques know to those well versed in the art.

In embodiments, the process of associating probe data with road segment data may be done through the navigational device 102 and the associated information may be sent to the collection facility 138. In other embodiments, the probe data may be collected and communicated from the navigational device 102 such that the association of the probe data and the road segment(s) can be done elsewhere. For example, the probe data may be sent to the collection facility 138 and then the probe data may be associated with road segment(s). In this case, the geographic database 152 may not be identical to the local geographic database 124 but instead be a different, presumably newer version of the geographic database 152. In embodiments some probe data from some vehicles may be associated with a local geographic database 124 in the vehicle and other probe data from other vehicles may be associated with a version of the geographic database 152 that resides at the geographic database management facility 104. In embodiments, once enough road segment associated probe data is collected the probe inference attribute facility 144 may make inferences about the data patterns.

In embodiments, the probe inference attribute facility 144 may be able to characterize a plurality of different road conditions, including intersection restrictions, road segment restrictions, geometry, and the like. Intersection restrictions may include stop signs, blinking stop and caution lights, detours, yield signs, no left turn signs, no right turn signs, no Uturn signs, and the like. Road restrictions may include speed limits, road capacity, one way road segments, and the like. Geometry may include existence of a median strip, width of road, number of lanes, positional coordinates, new roads and the like.

In embodiments, a detected change to probe inference attributes related to intersection restrictions for one or more segments may include the adding of a stop sign attribute. In this instance, the change in attribute may be indicated by a change in traffic pattern from an old traffic pattern to a new traffic pattern. For instance, and referencing the road network 108 diagram provided in FIG. 1, the old traffic pattern may be that traffic coming from C to G would drive through G without slowing, and traffic coming from E to G would always stop.

On that basis the probe inference attribute for the segment CG may be NO STOP SIGN. The new traffic pattern may be that traffic now always stops at G, whether coming from C or E. On that basis the probe inference attribute for the segment CG may be STOP SIGN. The comparison of these two probe inference attributes in this instance may be that a stop sign may have been added at G for traffic coming from C. In embodiments, there may have been a first probe inference attribute that the old traffic pattern did not have a stop sign and hence a first probe inference attribute of NO STOP SIGN, and a second inference that the new traffic pattern included a stop sign and hence a second probe inference attribute of STOP SIGN, where a comparison of the two probe inference attributes reveals a difference in road segment attribution. In embodiments, the difference in the road attribution may be made by comparing a probe inference attribute made about the road segment, to geographic database 152 attributes associated with the road segment.

In embodiments, the geographic database 152 may not have an attribute that can be inferred by the probe data. For example, in the previous paragraph, a database vendor may not have captured the attribute STOP SIGN in its database. In this case, the initial comparison may be made with the geographic database 152 for those probe-inferred segment attributes that generate a STOP SIGN value, that a change alert or other processing decision be generated on the basis that the geographic database 152 segment had an assumed attribute of NO STOP SIGN. In embodiments, a detected change to probe inference attributes related to an intersection restriction for one or more segments may include the adding of a blinking traffic light attribute. In this instance, the change in attribute may be indicated by a change in traffic pattern from an old traffic pattern to a new traffic pattern. For instance, and referencing the road network 108 diagram provided in FIG. 1, the old traffic pattern may be that traffic coming from C to G would drive through G without slowing, and traffic coming from E to G would always stop. This may result in a first probe-inferred attribute of STOP SIGN on segment EG and NO STOP SIGN on segment CG. The new traffic pattern may be that traffic now always slows at G when coming from C, and still always comes to a stop when coming from E. This may result in a second probe-inferred attribute of STOP SIGN on segment EG and a YIELD or BLINKING TRAFFIC LIGHT on segment CG. In embodiments, the difference in attribution on segment EG may trigger an alert for the geographic database 152. In embodiments, the first set of probe inferred attributes may show no difference when compared with the geographic database 152 and no alert may be generated, while the second set of probe-inferred attributes may show an attribute difference when compared with the geographic database 152, in which case a database alert may be generated.

In embodiments, a detected change to probe inference attributes related to an intersection restriction for one or more segments may include the adding of a tri-colored traffic light attribute. In this instance, the change in attribute may be indicated by a change in traffic pattern from an old traffic pattern to a new traffic pattern. For instance, and referencing the road network 108 diagram provided in FIG. 1, the old traffic pattern may be that traffic coming from C to G would drive through G without slowing, and traffic coming from E to G would always stop. On that basis the probe inference attribute for the segment CG may be NO TRI-COLORED TRAFFIC LIGHT. The new traffic pattern may be that traffic now sometimes stops, and sometimes drives through without slowing, whether coming from C or E. On that basis the probe inference attribute for the segment CG may be TRI-COLORED TRAFFIC LIGHT. The comparison of these two probe inference attributes in this instance may be that a traffic light may have been added at G for traffic coming from C. In embodiments, there may have been a first probe inference attribute that the old traffic pattern had no traffic restrictions associated with traffic traveling through the intersection G while traveling from C and hence a first probe inference attribute of NO TRI-COLORED TRAFFIC LIGHT, and a second inference that the new traffic pattern included a traffic light a G and hence a second probe inference attribute of TRI-COLORED TRAFFIC LIGHT, where a comparison of the two probe inference attributes reveals a difference in road segment attribution. In embodiments, the difference in the road attribution may be made by comparing a probe inference attribute made about the road segment, to geospatial database attributes associated with the road segment.

In embodiments, a detected change to probe inference attributes related to an intersection restriction for one or more segments may include the adding of a detour attribute. In this instance, the change in attribute may be indicated by a change in traffic pattern from an old traffic pattern to a new traffic pattern. For instance, and referencing the road network 108 diagram provided in FIG. 1, the old traffic pattern may be that most traffic going between points A and D would pass through B. On that basis the probe inference attribute for the segment may be NO DETOUR. The new traffic pattern may be that all traffic going between A and D now goes directly between A and D without going through B, traffic going between A and C continues, and no traffic is seen on road segment BD. On that basis the probe inference attribute for the segment may be DETOUR. The comparison of these two probe inference attributes in this instance may compare the inferences drawn between two instances in time, where the differences in this instance may indicate that road segment BD may be blocked (at least in the direction B to D), and that a detour may be taking traffic going between A and D through road segment AD. In embodiments, the difference in the road attribution may be made by comparing a probe inference attribute made about the road segment, to geospatial database attributes associated with the road segment.

In embodiments, a detected change to probe inference attributes related to an intersection restriction for one or more segments may include the change from a stop sign attribute to a yield sign attribute. In this instance, the change in attribute may be indicated by a change in traffic pattern from an old traffic pattern to a new traffic pattern. For instance, and referencing the road network 108 diagram provided in FIG. 1, the old traffic pattern may be that all traffic going from F to H would stop at H. On that basis the probe inference attribute for the segment FH may be STOP SIGN. The new traffic pattern may be that some traffic still stops, but many now slow before proceeding. On that basis the probe inference attribute for the segment FH may be YIELD SIGN. In embodiments, there may have been a first probe inference attribute that the old traffic pattern had a stop sign restriction at the end of road segment FH and hence a first probe inference attribute of STOP SIGN, and a second inference that the new traffic pattern had a yield sign restriction at the end of road segment FH and hence a second probe inference attribute of YIELD SIGN, where a comparison of the two probe inference attributes reveals a difference in road segment attribution. In embodiments, the difference in the road attribution may be made by comparing a probe inference attribute made about the road segment, to geospatial database attributes associated with the road segment.

In embodiments, a detected change to probe inference attributes related to an intersection restriction for one or more segments may include the adding of a no left turn sign attribute. In this instance, the change in attribute may be indicated by a change in traffic pattern from an old traffic pattern to a new traffic pattern. For instance, and referencing the road network 108 diagram provided in FIG. 1, the old traffic pattern may be that traffic going from G to E would sometimes turn towards D, and sometimes turn toward H. On that basis the probe inference attribute for the segment GE may be LEFT TURN. The new traffic pattern may be that traffic now only turns toward D, and traffic continues to travel in both directions along road segment DH. On that basis the probe inference attribute for the segment GE may be NO LEFT TURN. The comparison of these two probe inference attributes in this instance may be that there was no turn restriction for the intersection at E for traffic coming from G, and a second probe inference attribute that there is now a NO-LEFT TURN SIGN placed at E for traffic coming from G, where a comparison of the two probe inference attributes reveals a difference in road segment attribution. In embodiments, the difference in the road attribution may be made by comparing an probe inference attribute made about the road segment, to geospatial database attributes associated with the road segment.

In embodiments, a detected change to probe inference attributes related to an intersection restriction for one or more segments may include the adding of a no U-turn sign attribute. In this instance, the change in attribute may be indicated by a change in traffic pattern from an old traffic pattern to a new traffic pattern. For instance, and referencing the road network 108 diagram provided in FIG. 1, the old traffic pattern may be that traffic would travel from G to C, and then immediately travel from C to G a certain percent of the time. On that basis the probe inference attribute for the segment CG may be U-TURN. The new traffic pattern may be that this percentage becomes significantly reduced. On that basis the probe inference attribute for the segment CG may be NO U-TURN. The comparison of these two probe inference attributes in this instance may be that there was no turn restriction for the intersection at C for traffic coming from G and hence a first probe inference attribute of U-TURN, and a second inference that there is now a no U-turn sign placed at C for traffic coming from G and hence a second probe inference attribute of NO U-TURN, where a comparison of the two probe inference attributes reveals a difference in road segment attribution. In embodiments, the difference in the road attribution may be made by comparing a probe inference attribute made about the road segment, to geospatial database attributes associated with the road segment. In embodiments, a detected change to probe inference attributes related to a road segment restriction for one or more segments may include the decrease in the speed limit attribute. In this instance, the change in attribute may be indicated by a change in traffic pattern from an old traffic pattern to a new traffic pattern. For instance, and referencing the road network 108 diagram provided in FIG. 1, the old traffic pattern may be that traffic travelling along road segment CG travels an average speed of X in both directions. On that basis the probe inference attribute for the segment may be SPEED LIMIT X. The new traffic pattern may be that X becomes significantly reduced. On that basis the probe inference attribute for the segment may be SPEED LIMIT X(−). The inference in this instance may be that there was a speed limit of X on the road segment CG and hence a first probe inference attribute of SPEED LIMIT X, and a second inference that there is now a speed limit of less than X on the road segment CG and hence a first probe inference attribute of SPEED LIMIT X(−), where a comparison of the two probe inference attributes reveals a difference in road segment attribution. In embodiments, the difference in the road attribution may be made by comparing a probe inference attribute made about the road segment, to geospatial database attributes associated with the road segment.

In embodiments, a detected change probe inference attributes related to a road segment restriction for one or more segments may include the change in direction attributes, such as attributes for one-way. In this instance, the change in attribute may be indicated by a change in traffic pattern from an old traffic pattern to a new traffic pattern. For instance, and referencing the road network 108 diagram provided in FIG. 1, the old traffic pattern may be that traffic only goes in the direction from A to D. On that basis the probe inference attribute for the segment AD may be ONE-WAY A-TO-D. The new traffic pattern may be that traffic now only travels in the direction from D to A. On that basis the probe inference attribute for the segment AD may be ONE-WAY D-to-A. The inference in this instance may be that there was a one-way sign facing in the direction of A to D and hence a first probe inference attribute of ONE-WAY A-TO-D, and a second inference that there is now a one-way sign facing in the direction from D to A and hence a second probe inference attribute of ONE-WAY A-TO-D, where a comparison of the two probe inference attributes reveals a difference in road segment attribution. In embodiments, the difference in the road attribution may be made by comparing a probe inference attribute made about the road segment, to geospatial database attributes associated with the road segment.

In embodiments, a detected change to probe inference attributes related to a road segment restriction for one or more segments may include a closed road attribute. In this instance, the change may be indicated by a change in traffic pattern from an old traffic pattern to a new traffic pattern. For instance, and referencing the road network 108 diagram provided in FIG. 1, the old traffic pattern may be that traffic proceeds in both directions along road segment AD. On that basis the probe inference attribute for the segment AD may be BI-DIRECTIONAL TRAFFIC. The new traffic pattern may be that no traffic proceeds along road segment AD. On that basis the probe inference attribute for the segment AD may be ROAD CLOSED. The comparison of these two probe inference attributes in this instance may be that there was no directional road restrictions for the road segment AD and hence a first probe inference attribute of BI-DIRECTIONAL TRAFFIC, and a second inference that no traffic is permitted along road segment AD and hence a second probe inference attribute of ROAD CLOSED, where a comparison of the two probe inference attributes reveals a difference in road segment attribution.

In embodiments, the difference in the road attribution may be made by comparing a probe inference attribute made about the road segment, to geospatial database attributes associated with the road segment.

In embodiments, a new road segment may be detected. In this instance there may be no road segment referenced in the geographic database 152 directly between intersections D and G in the road network 108. In embodiments, without a referenced road segment DG in the geographic database 152, there may be no segment assignment made. However, if probe data begins to appear for traffic traveling along a road segment DG, a probe inference attribute may be drawn that a road segment exists between D and G. In embodiments, an inference drawn from a road segment that has no geographic database reference may indicate that a new road exists. In embodiments, the difference in the road attribution may be made by comparing a probe inference attribute made about the road segment, to geospatial database attributes associated with the road segment.

In terms of probe data, it is to be mentioned that this may comprise raw sensor data, optionally pre-processed to derive tangible and/or representative probe characteristics such as speed, heading, attitude, time, and the like, and that such probe data may be derived from any of a number of platforms, for example personal navigation devices, in-vehicle integrated navigation systems, dedicated mapping vans or similar vehicles incorporating various digital mapping equipment and apparatus.

It should be acknowledged that the preceding embodiments are meant to be illustrating, and are not meant to be limiting in any way. One skilled in the art would recognize that a plurality of other road attribution changes may be similarly detected from drawn probe inference attributes of road attribution based on vehicle probe data, and that the present invention may accommodate the detection of all such changes in a similar manner.

What is claimed is:

1. A method, comprising
collecting probe sensor data in an area containing roads and other drivable features;
processing said probe sensor data in a first manner so as to create a geospatial map database comprising road segments, and in a second manner to derive a subset of data related to at least one segment within the geospatial map database and being indicative of an attribute thereof,
statistically processing said subset data per road segment to determine one or more inferred attributes thereof,
comparing said created geospatial map database, in particular the road segments identified therein and said inferred attributes thereof with a pre-existing geospatial map database containing road segments and attributes thereof, and where an inconsistency in the presence or absence of a road segment, or in its geometry or topology, or in any of its attributes, is identified,
effecting a further action, being one of:
(a) Generating a change notification
(b) Generating an alert
(c) Generating a change request,
the ultimate operation of such further action being the eventual update of the pre-existing geospatial map database such that the former attribute is replaced with at least one of the inferred attribute, and/or the insertion, deletion or correction, as far as geometry and topology is concerned, of the road segment.

2. A method according to claim 1 wherein the first processing manner is statistical in nature such that road segments are included in said geospatial map database only if a plurality of probe sensor data indicate that said road segments exist.

3. A method, comprising
collecting probe sensor data in an area containing roads and other drivable features;
communicating the probe sensor data to a collection facility,
associating the probe sensor data with one or more road segments stored in a geospatial database, said road segments having one or more attributes;
storing the road segment associated probe sensor data as a first data set independently of said geospatial database,
repeating the above collecting, communicating, associating, and storing steps to provide second and optionally further data sets,
comparing one data set with another to identify discrepancies betwixt data sets in terms of both road segments and their attributes, and
for each discrepancy, effecting a further action, being one of:
(a) Generating a change notification
(b) Generating an alert
(c) Generating a change request,
the ultimate operation of such further action being the eventual update of the geospatial database as regards those road segments and attributes identified as a result of said comparison such that at least one of the following occurs:
the former attribute is replaced with the inferred attribute, and,
in the case of a road segment, the insertion, deletion or correction, as far as geometry and topology is concerned, thereof.

4. A method according to claim 3 wherein the step of associating probe sensor data with one or more road segments stored in a geospatial database, said road segments having one or more attributes is effected locally at the probe, said geospatial database being provided locally at the probe location, or integrally within said probe.

5. A method, comprising
collecting probe sensor data in an area containing roads and other drivable features;
processing said data so as to create a first geospatial map database comprising road segments, and from said probe sensor data, further deriving a separate body of data, related to one or more segments within the geospatial map database and being indicative of an attribute thereof,
statistically processing said separate body of data per road segment to determine one or more inferred attributes thereof,
combining the inferred attributes of road segments with the first geospatial map database to produce a first probe data-created geospatial map database,
effecting a conflation between the first probe data-created geospatial map database thus created and a second, pre-existing master geospatial map database to give rise to an improved third master geospatial map database.

6. A method, comprising
collecting probe sensor data over a first time period in an area containing roads and other drivable features;
processing said data so as to create a first geospatial map database comprising road segments, and also from said probe sensor data, further deriving a separate body of data, related to at least one segment within the geospatial map database and being indicative of an attribute thereof,
statistically processing said separate body of data per road segment to determine one or more inferred attributes thereof,
combining the inferred attributes of road segments with the first geospatial map database to produce a first probe data created geospatial map database,
repeating the collecting, processing and combining steps above for probe data collected during a second time period to produce a second probe data generated geospatial map database,
effecting a first comparison between the first and second geospatial map databases thus created to identify road segments, geometry, topology or attributes thereof that have changed between said first time period and said second time period,
effecting a second comparison between only those identified road segments, geometry, topology or attributes thereof having changed over time and a pre-existing master database, and if said second comparison determines that the road segments, geometry, topology, or attributes thereof present in the master geospatial database are at odds with the identified road segments, geometry, topology or attributes thereof,
effecting a further action, being one of:
(a) Generating a change notification for said master database
(b) Generating an alert
(c) Generating a change request,
the ultimate effect of such further action being the eventual update of the master geospatial database as regards at least one or more of those road segments, geometry, topology or attributes thereof being at odds with the identified road segments, geometry, topology or attributes thereof, such update being that the former are replaced with the latter, and/or in the case of an identified road segment being absent from the master geospatial database, the insertion thereof therein.

7. A method according to claim 1, wherein the geospatial database resulting from the performance of said methods is provided to end users as part of an update facility to any local geospatial database in use thereby.

8. A method according to claim 1, wherein the attributes of a road segment are any chosen from a list comprising:
intersection restrictions including at least one of stop signs, traffic lights of various kinds, blinking stop and caution lights, detours, yield signs, no left turn signs, no right turn signs, no U-turn signs,
road segment restrictions, including speed limits, road capacity, one-way road segments,
geometry restrictions, including at least one of the presence or absence of, and details of a median strip, width of road, number of lanes, positional coordinates, and whether the road is newly created and/or its relative or actual age, and slope.

9. A method according to claim 2, wherein the geospatial database resulting from the performance of said methods is provided to end users as part of an update facility to any local geospatial database in use thereby.

10. A method according to claim 2, wherein the attributes of a road segment are any chosen from a list comprising:
intersection restrictions including at least one of stop signs, traffic lights of various kinds, blinking stop and caution lights, detours, yield signs, no left turn signs, no right turn signs, no U-turn signs,
road segment restrictions, including at least one of speed limits, road capacity, one-way road segments,
geometry restrictions, including the presence or absence of, and details of a median strip, width of road, number of lanes, positional coordinates, and whether the road is newly created and/or its relative or actual age, and slope.

11. A method according to claim 3, wherein the geospatial database resulting from the performance of said methods is provided to end users as part of an update facility to any local geospatial database in use thereby.

12. A method according to claim 3, wherein the attributes of a road segment are any chosen from a list comprising:
intersection restrictions including at least one of stop signs, traffic lights of various kinds, blinking stop and caution lights, detours, yield signs, no left turn signs, no right turn signs, no U-turn signs,
road segment restrictions, including speed limits, road capacity, one-way road segments,
geometry restrictions, including at least one of the presence or absence of, and details of a median strip, width of road, number of lanes, positional coordinates, and whether the road is newly created and/or its relative or actual age, and slope.

13. A method according to claim 4, wherein the geospatial database resulting from the performance of said methods is provided to end users as part of an update facility to any local geospatial database in use thereby.

14. A method according to claim 4, wherein the attributes of a road segment are any chosen from a list comprising:
intersection restrictions including at least one of stop signs, traffic lights of various kinds, blinking stop and caution lights, detours, yield signs, no left turn signs, no right turn signs, no U-turn signs,
road segment restrictions, including speed limits, road capacity, one-way road segments,
geometry restrictions, including at least one of the presence or absence of, and details of a median strip, width of road, number of lanes, positional coordinates, and whether the road is newly created and/or its relative or actual age, and slope.

15. A method according to claim 5, wherein the geospatial database resulting from the performance of said methods is provided to end users as part of an update facility to any local geospatial database in use thereby.

16. A method according to claim 5, wherein the attributes of a road segment are any chosen from a list comprising:
intersection restrictions including at least one of stop signs, traffic lights of various kinds, blinking stop and caution lights, detours, yield signs, no left turn signs, no right turn signs, no U-turn signs,
road segment restrictions, including speed limits, road capacity, one-way road segments,
geometry restrictions, including at least one of the presence or absence of, and details of a median strip, width of road, number of lanes, positional coordinates, and whether the road is newly created and/or its relative or actual age, and slope.

17. A method according to claim 6, wherein the geospatial database resulting from the performance of said methods is provided to end users as part of an update facility to any local geospatial database in use thereby.

18. A method according to claim 6, wherein the attributes of a road segment are any chosen from a list comprising:
intersection restrictions including at least one of stop signs, traffic lights of various kinds, blinking stop and caution lights, detours, yield signs, no left turn signs, no right turn signs, no U-turn signs,
road segment restrictions, including speed limits, road capacity, one-way road segments,
geometry restrictions, including at least one of the presence or absence of, and details of a median strip, width of road, number of lanes, positional coordinates, and whether the road is newly created and/or its relative or actual age, and slope.
